(19) United States
(12) Patent Application Publication
(10) Pub. No.: US 2008/0117193 A1
(43) Pub. Date: May 22, 2008

(54) Plasma display device and driving method thereof

(75) Inventor: Seung-Hun Chae, Suwon-si (KR)

Correspondence Address: LEE & MORSE, P.C., 3141 FAIRVIEW PARK DRIVE, SUITE 500, FALLS CHURCH, VA, 22042, US

(73) Assignee: Samsung SDI Co., Ltd.

(21) Appl. No.: 11/976,082

(22) Filed: Oct. 19, 2007

(30) Foreign Application Priority Data
Nov. 20, 2006 (KR) 10-2006-0114688

(51) Int. Cl. G06F 3/038; G09G 3/28

(52) U.S. Cl. 345/204; 345/66

(57) ABSTRACT

A method for driving a plasma display device having a plurality of row electrodes and a plurality of discharge cells corresponding to the row electrodes, in which a field is divided into a plurality of subfields, the method including dividing the plurality of row electrodes into at least a first row group and a second row group, dividing the first row group into a plurality of first subgroups, dividing the second row group into a plurality of second subgroups, address-discharging one of the first subgroups while sustain-discharging a corresponding one of the second subgroups during a predetermined subfield of a first field, address-discharging the first subgroups in a first order during the predetermined subfield of the first field, and address-discharging the first subgroups in a second order during a corresponding subfield of a second field, wherein the second field is consecutive to the first field.

### CROSS-REFERENCE TO RELATED APPLICATION

This application is related to co-pending U.S. patent application Ser. No. ______, entitled “PLASMA DISPLAY DEVICE AND DRIVING METHOD THEREOF,” which was filed on Oct. 19, 2007, and is incorporated by reference herein in its entirety.

### BACKGROUND OF THE INVENTION

1. Field of the Invention

Embodiments relate to a plasma display device and a method of driving the same.

2. Description of the Related Art

A plasma display device is a flat panel display device that uses plasma generated by a gas discharge to display images, e.g., text, video, etc. It may include a plasma display panel (PDP) having, depending on its size, tens to millions of discharge cells, which may be arranged in a matrix format.

In operation of the plasma display device, a field (e.g., one TV field) may be divided into respectively weighted subfields. Grayscales may be expressed by a combination of weights from among the subfields. A discharge cell to be turned on, i.e., to be placed in a light-emitting state, may be selected by performing an addressing discharge for an address period of each subfield. The turned-on, i.e., light-emitting, discharge cell may be sustain-discharged during a period corresponding to a weight of the corresponding subfield in a sustain period of each field. The plasma display may use a plurality of subfields each having a different weight in order to express grayscales. A sum of weight values of subfields having discharge cells in the light emitting state among a plurality of subfields may represent a gray scale of the corresponding discharge cell.

The operation described above of expressing grayscales using subfields may cause a dynamic false contour. For example, when using subfields with weights set to 2ⁿ, a dynamic false contour may occur when discharge cells express grayscales of 127 and 128 in consecutive fields.

An additional address period may be provided to each subfield for addressing all discharge cells, in addition to the sustain period for sustain-discharging, which may increase the length of a subfield. The increased length of the subfield may limit the number of subfields that can be used in a field.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments are therefore directed to a plasma display device and a method of driving the same, which substantially overcome one or more of the problems due to the limitations and disadvantages of the related art.

It is therefore a feature of an embodiment to provide a plasma display device, and a method of driving the same, in which a plurality of row electrodes may be divided into groups, which may in turn be further divided into subgroups, and in which an address period of one subgroup may be performed while a sustain period of another subgroup is being performed.

It is therefore another feature of an embodiment to provide a plasma display device, and a method of driving the same, in which a luminance difference between subgroups may be reduced by changing an addressing operation order between subgroups for different fields.

At least one of the above and other features and advantages may be realized by providing a method for driving a plasma display device having a plurality of row electrodes and a plurality of discharge cells corresponding to the row electrodes, in which a field is divided into a plurality of subfields, the method including dividing the plurality of row electrodes into at least a first row group and a second row group, dividing the first row group into a plurality of first subgroups, dividing the second row group into a plurality of second subgroups, address-discharging one of the first subgroups while sustain-discharging a corresponding one of the second subgroups during a predetermined subfield of a first field, address-discharging the first subgroups in a first order during the predetermined subfield of the first field, and address-discharging the first subgroups in a second order during a corresponding subfield of a second field. The second field may be consecutive to the first field.

The method may further include address-discharging the second subgroups in the first order during the predetermined subfield of the first field, and address-discharging the second subgroups in the second order during the corresponding subfield of the second field. A number n of each of the first and second subgroups may be greater than 2, n being an integer, and the method may further include address-discharging each of the first and second subgroups in an nth order during a corresponding subfield of a n^{th} field, and address-discharging each of the first and second subgroups in the first order during a corresponding subfield of an n+1^{th} field, wherein the first through ninth fields may be consecutive. A subgroup that is address-discharged last during the first field may be address-discharged first during the n^{th} field.

The method may further include address-discharging the second subgroups in a third order during the predetermined subfield of the first field, and address-discharging the second subgroups in a fourth order during the corresponding subfield of the second field. The method may further include sustain-discharging each of the first and second subgroups in the first order during the first field, and sustain-discharging each of the first and second groups in the second order during the second field.

The one of the first subgroups may be address-discharged during a last portion of the predetermined subfield in the first field, and the one of the first subgroups may be address-discharged during a first portion of the predetermined subfield in the second field. Address-discharging each of the first and second subgroups may be done in a repeating cycle having a predetermined number of orders, such that the cycle repeats after a number of fields that is one greater than the number of orders, and a subgroup that is address-discharged last during an initial field of the cycle may be address-discharged first during a last field of the cycle.

The row electrodes may include sustain electrodes and scan electrodes, each of the first subgroups may be driven with a same sustain electrode signal, and each of the first subgroups may be driven with a different scan electrode signal, the different scan electrode signals being determined in accordance with the first order.

A first subgroup of the plurality of first subgroups may be address-discharged during an initial portion of the first field, and a second subgroup of the plurality of first subgroups may be address-discharged after the first subgroup during the first field, and the second subgroup of the plurality of first subgroups may be address-discharged during an initial portion of the second field.

Consecutive address-discharging operations may alternate between the first and second row groups and may increase sequentially within row groups in a repeating cycle. An initial address-discharging operation may be performed on a first subgroup of the plurality of first subgroups, a first subsequent address-discharging operation may be performed on a first subgroup of the plurality of second subgroups, and a second subsequent address-discharging operation may be performed on a second subgroup of the plurality of first subgroups.

At least one of the above and other features and advantages may also be realized by providing a plasma display device including a plasma display panel having a plurality of row electrodes and a plurality of discharge cells corresponding to the row electrodes, a controller configured to divide the plurality of row electrodes into at least a first row group and a second row group, to divide the first row group into a plurality of first subgroups, and to divide the second row group into a plurality of second subgroups, and a driver configured to address-discharge one of the first subgroups while sustain-discharging a corresponding one of the second subgroups during a predetermined subfield of a first field, to address-discharge the first subgroups in a first order during the predetermined subfield of the first field, and to address-discharge the first subgroups in a second order during a corresponding subfield of a second field. The second field may be consecutive to the first field.

A number n of each of the first and second subgroups may be greater than 2, n being an integer, and the driver may address-discharge each of the first and second subgroups in an n^{th} order during a corresponding subfield of a nth field, and address-discharge each of the first and second subgroups in the first order during a corresponding subfield of an n+1^{th} field, the first through ninth fields being consecutive. A subgroup that is address-discharged last during the first field may be address-discharged first during the nth field.

The driver may address-discharge the second subgroups in a third order during the predetermined subfield of the first field, and address-discharge the second subgroups in a fourth order during the corresponding subfield of the second field.

The driver may sustain-discharge each of the first and second subgroups in the first order during the first field, and may sustain-discharge each of the first and second groups in the second order during the second field.

The driver may address discharge each of the first and second subgroups in a repeating cycle having a predetermined number of orders, such that the cycle repeats after a number of fields that is one greater than the number of orders, and a subgroup that is address-discharged last during an initial field of the cycle may be address-discharged first during a last field of the cycle.

The driver may address-discharge a first subgroup of the plurality of first subgroups during an initial portion of the first field, and address-discharge a second subgroup of the plurality of first subgroups after the first subgroup during the first field, and the driver may address-discharge the second subgroup of the plurality of first subgroups during an initial portion of the second field.

Consecutive address-discharging operations may alternate between the first and second row groups and may increase sequentially within row groups in a repeating cycle.

The driver may perform an initial address-discharging operation on a first subgroup of the plurality of first subgroups, perform a first subsequent address-discharging operation on a first subgroup of the plurality of second subgroups, and perform a second subsequent address-discharging operation on a second subgroup of the plurality of first subgroups.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a plasma display device according to an embodiment;

FIG. 2 illustrates a grouping of electrodes in a method of driving a plasma display device according to an embodiment;

FIG. 3 illustrates subfields in the driving method of FIG. 2;

FIG. 4 illustrates another view of subfields in the driving method of FIG. 2;

FIG. 5 illustrates a driving waveform of a plasma display device in the driving method of FIG. 2; and

FIGS. 6A to 6H illustrate, respectively, an order of address periods of subgroups in first to eighth fields in the driving method of FIG. 2.

### DETAILED DESCRIPTION OF THE INVENTION

Korean Patent Application No. 10-2006-0114688, filed on Nov. 20, 2006, in the Korean Intellectual Property Office, and entitled: “Plasma Display and Driving Method Thereof,” is incorporated by reference herein in its entirety.

Embodiments will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

As used herein, “wall charges” refer to charges formed and accumulated on a wall (e.g., a dielectric layer) close to an electrode of a discharge cell. A wall charge may be described as being “formed” or “accumulated” on the electrodes, although the wall charges may not actually touch the electrodes. Further, a “wall voltage” refers to a potential difference formed on the wall of the discharge cell by the wall charge.

Address-discharging may include a selective writing method used to select discharge cells that are to emit light (hereinafter referred to as light emitting cells). A selective erase method may be used to select discharge cells that are to emit no light (hereinafter referred to as non-light emitting cells). The selective writing method may select a discharge cell that is to be a light emitting cell and generate a constant wall voltage. Using the selective writing method, cells that are in the non-light emitting state may be address-discharged, such that wall charges may be formed and the non-light emitting state may be switched to the light emitting state. The address-discharge that forms the wall charge in the selective write method may be called a “write discharge.”

The selective erase method may select a cell that is to be a non-light emitting cell and erase the wall voltage. Using the selective erase method, cells in the light emitting state may be address-discharged, such that wall charges that had already been formed are erased and the light emitting state may be switched to the non-light emitting state. The address discharge that erases the wall charge in the selective erase method may be called an “erase discharge.”

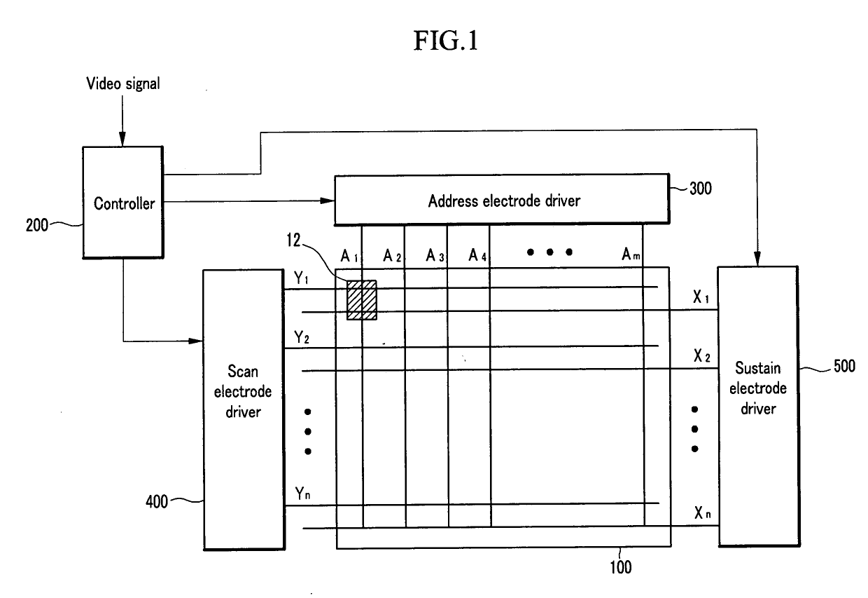

FIG. 1 illustrates a plasma display device according to an embodiment. Referring to FIG. 1, the plasma display device may include a PDP 100, a controller 200, an address electrode driver 300, a scan electrode driver 400, and a sustain electrode driver 500.

The PDP 100 may include a plurality of address electrodes A₁ to Aₘ, which may extend in a column direction. The PDP 100 may also include a plurality of sustain electrodes X₁ to Xₙ and a plurality of scan electrodes Y₁ to Yₙ, which may extend in a row direction and may cross the address electrodes A₁ to Aₘ. The Y electrodes Y₁ to Yₙ and the X electrodes X₁ to Xₙ may extend parallel to each other. The address electrodes, the sustain electrodes, and the scan electrodes will be generally referred to as A electrodes, X electrodes, and Y electrodes, respectively. The X and Y electrodes may be generally referred to as row electrodes, and the A electrodes may be generally referred to as column electrodes. The sustain electrodes X may be paired with the scan electrodes Y, such that the X electrodes X₁ to Xₙ may respectively correspond to the Y electrodes Y₁ to Yₙ. An X electrode and a Y electrode of a pair may perform a display operation in order to display an image during a sustain period.

A discharge cell 12 may include a space formed at a region where an A electrode of the A electrodes A₁ to Aₘ crosses corresponding ones of the X and Y electrodes X₁ to Xₙ and Y₁ to Yₙ.

The above-described structure of the PDP 100 is merely exemplary, and panels of other structures may also be employed.

The controller 200 may receive externally-supplied video signals and may output an A electrode driving control signal, an X electrode driving control signal, and a Y electrode driving control signal. The controller 200 may control the plasma display device by dividing a field into a plurality of subfields. The controller 200 may divide the row electrodes into a first group and a second group. Further, the controller 200 may divide the first group into a plurality of subgroups, and may divide the second group into a plurality of subgroups.

The address electrode driver 300 may receive an A electrode driving control signal from the controller 200, and may supply a display data signal, for selecting discharge cells to be displayed, to the corresponding A electrodes.

The scan electrode driver 400 may receive the Y electrode driving control signal from the controller 200, and may supply a driving voltage to the Y electrode.

The sustain electrode driver 500 may receive the X electrode driving control signal from the controller 200, and may supply a driving voltage to the X electrode.

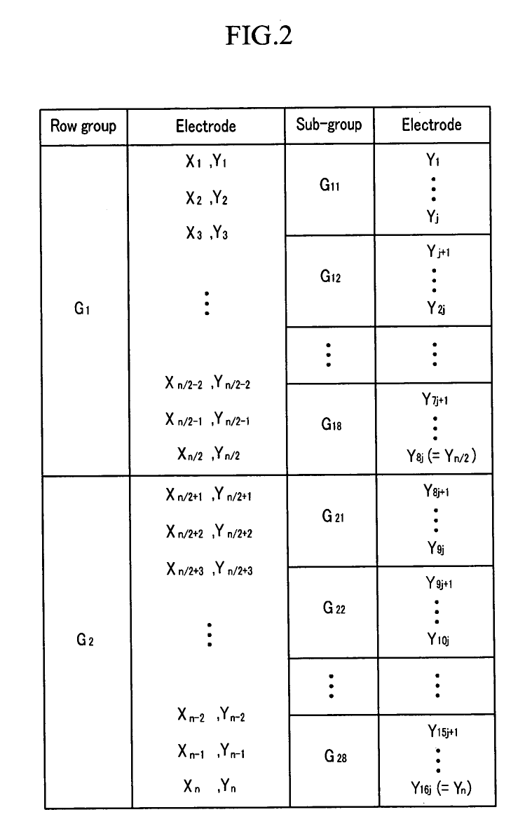

A method for driving the plasma display according to the exemplary embodiment of the present invention will now be described with reference to FIG. 2.

FIG. 2 illustrates a grouping of electrodes in a method of driving a plasma display device according to an embodiment. Referring to FIG. 2, in one field, row electrodes X₁ to Xₙ and Y₁ to Yₙ may be divided into two row groups G₁ and G₂. Row electrodes X₁ to X_{n/2} and Y₁ to Y_{n/2}, which may be positioned in a top portion of the PDP 100, may be grouped into the first row group G₁. Row electrodes X_{n/2+1} to Xₙ and Y_{n/2+1} to Yₙ, which may be positioned in a bottom portion of the PDP 100, may be grouped into the second group G₂.

In another implementation (not shown), even-numbered row electrodes may be grouped into a first row group G₁and odd-numbered row electrodes may be grouped into a second row group G₂. Further, the number of row groups is not limited to two.

Y electrodes in the first row group G₁may be further divided into subgroups G₁₁ to G₁₈. Y electrodes in the second row group G₂ may be further divided into subgroups G₂₁ to G₂₈. For the sake of description, in FIG. 2 the first and second row groups G₁ and G₂ are respectively divided into eight subgroups G₁₁ to G₁₈ and G₂₁ to G₂₈. However, a different number of subgroups may be used.

In the first row group G₁, the Y electrodes Y₁ to Yⱼ may be grouped into the subgroup G₁₁, the Y electrodes Yⱼ₊₁ to Y₂ⱼ may be grouped into the subgroup G₁₂, . . . , and the Y electrodes Y₇ⱼ₊₁ to Y₈ⱼ (Y_{n/2}) may be grouped in the subgroup G₁₈, where j is an integer and may be between, e.g., 1 and n/16, where n is an integer representing a number of row electrodes, e.g., a number of scan electrodes Y.

In a like manner, in the second row group G₂, the Y electrodes Y₈ⱼ₊₁ to Y₉ⱼ may be grouped into the subgroup G₂₁, the Y electrodes Y₉ⱼ₊₁ to Y₁₀ⱼ may be grouped into the subgroup G₂₂, . . . , and the Y electrodes Y₁₅ⱼ₊₁ to Yₙ may be grouped into the subgroup G₂₈.

Y electrodes having a constant distance from each other in the first and second row groups G₁and G₂ may be grouped into one subgroup. In another implementation, the Y electrodes may be grouped according to an irregular order.

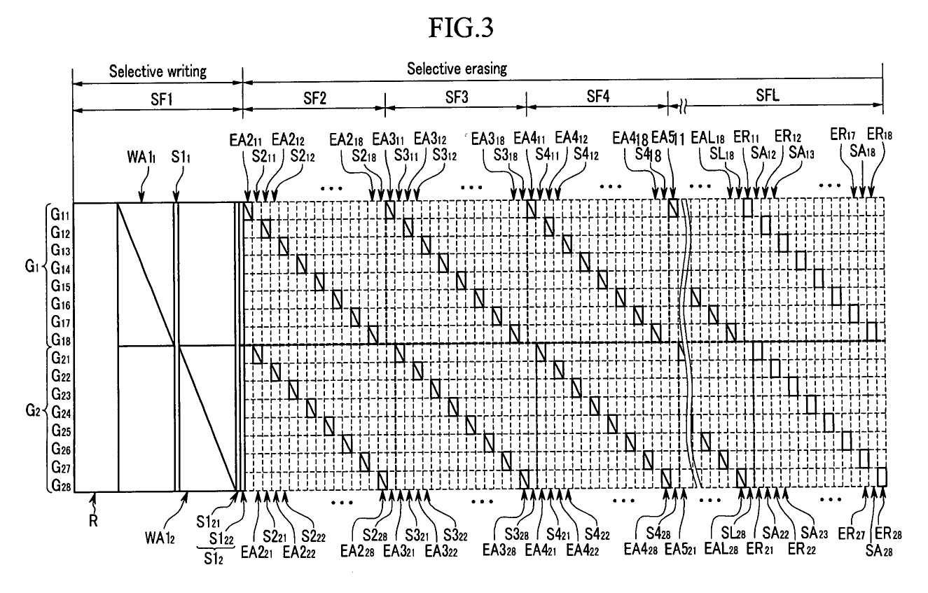

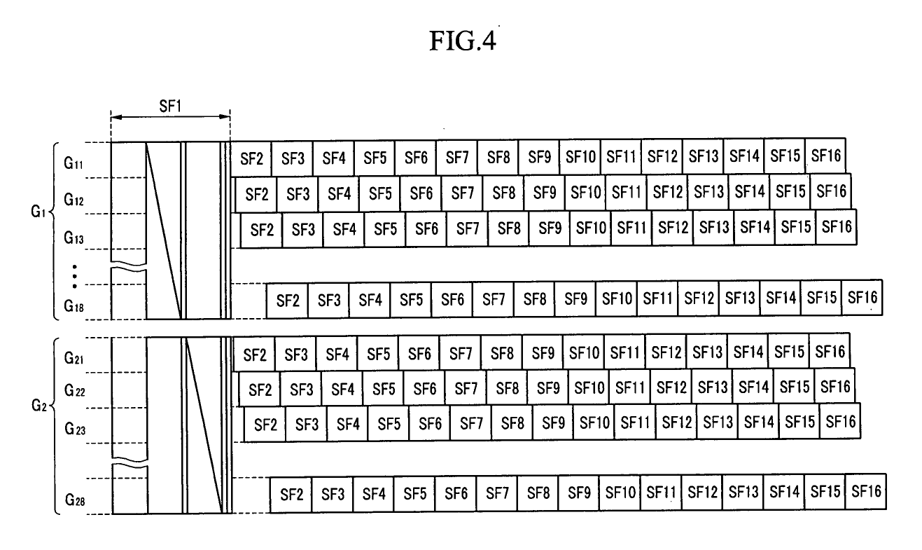

FIG. 3 illustrates subfields in the driving method of FIG. 2, and FIG. 4 illustrates another view of subfields in the driving method of FIG. 2. Referring to FIG. 3, one field may be divided into L subfields SF1 to SFL. L is an integer and may be, e.g., 16. The first subfield SF1 may include a reset period R, write address periods WA1₁ and WA1₂, and sustain periods S1₁ and S1₂. The selective write method may be applied to the address periods WA1₁ and WA1₂.

The second to L-th subfields SF2 to SFL may include address periods EA2₁₁ to EAL₁₈ and EA2₂₁ to EAL₂₈, and sustain periods S2₁₁ to SL₁₈ and S2₂₁ to SL₂₈. A selective erase address method may be applied to the address periods EA2₁₁ to EAL₁₈ and EA2₂₁ to EAL₂₈ of the second to L-th subfields SF2 to SFL.

As described above with reference to FIG. 2, the row electrodes X₁ to Xₙ and Y₁ to Yₙ may be respectively grouped into first and second row groups G₁and G₂, and the first and second row groups G₁and G₂ may respectively include the Y electrodes Y₁ to Yₙ grouped into subgroups G₁₁ to G₁₈ and G₂₁ to G₂₈.

Referring to FIG. 3, in the first subfield having the address periods WAl₁ and WAl₂ employing the selective writing method, a reset period R may be provided temporally before the address periods WA1₂ and WA1₂ so as to initialize all of the discharge cells to be in the non-light emitting state. That is, in the reset period R of the first subfield SF1, all discharge cells may be reset to be non-light emitting cells so that they can be write-discharged in the address periods WA1₁ and WA1₂-Wall charges may be formed by write-discharging discharge cells that are to be set as light emitting cells in the address period WA1₁, and light emitting cells of the first row group G₁may be sustain-discharged in the sustain period S1₁. In this case, a minimum number of sustain discharges (e.g., one or two) may be generated in the sustain period S1₁.

In the address period WA1₂, wall charges may be formed by write-discharging discharge cells selected to be light emitting cells from among discharge cells of the second row group G₂. Discharge cells of the first and second row groups G₁and G₂ may be sustain-discharged in a partial period S1₂₁ of the sustain period S1₂. In addition, the light emitting cells of the second row group G₂ may be sustain-discharged while the light emitting cells of the first row group G₁are not in the state of being sustain-discharged during the partial period S1₂₂ of the sustain period S1₂. The number of sustain discharges generated in the discharge cells of the second row group G₂ during the partial period S1₂₂ of the sustain period S1₂ may be set to correspond to the number of sustain discharges generated in the discharge cells of the first row group G₁during the sustain period S1₂.

Also, in the case that the two sustain periods S1₁ and S1₂ do not satisfy a weight value of the first subfield SF1, the light emitting cells of the first and second row groups G₁and G₂ may be additionally sustain-discharged during the partial period S1₂₂ of the sustain period S1₂.

In the second subfield SF2, the address periods EA2₁₁ to EA2₁₈ and the sustain periods S2₁₁ to SL₁₈ may be sequentially applied from the subgroup G₁₁ to the subgroup G₁₈ of the first row group G₁, and the address periods EA2₂₁ to EA2₂₈ and the sustain periods S2₂₁ to SL₂₈ may be sequentially applied from the subgroup G₂₁ to the subgroup G₂₈.

The address periods EA3₁₁ to EAL₁₈ and EA3₂₁ to EAL₂₈ and the sustain periods S3₁₁ to SL₁₈ and S3₂₁ to SL₂₈ may be applied to the third through L-th subfields in similar fashion to that described above for the second subfield SF2. Since address and sustain operations during the address periods EA2₁₁ to EAL₁₈ and EA2₂₁ to EAL₂₈ and the sustain periods S2₁₁ to SL₁₈ and S2₂₁ to SL₂₈ may be substantially the same for the subfields SF2 to SFL, hereinafter these operations will be generally described as address operations EAk₁₁ to EAk₁₈ and EAk₂₁ to EAk₂₈ and sustain operations Sk₁₁ to Sk₁₈ and Sk₂₁ to Sk₂₈ applied to a k-th subfield SFk (where k is an integer, 2≦k≦L).

The sustain period S₁ᵢ may be applied to the subgroup G₁ᵢ after the address period EAk₁ᵢ is applied thereto in the subfield SFk of the row group G₁ (where i is an integer, 1≦i≦8). Subsequently, the address period EAk₁₍ᵢ₊₁₎ and the sustain period Sk₁₍ᵢ₊₁₎ may be applied to the subgroup G₁₍ᵢ₊₁₎.

In the subfield SFk of the second row group G₂, the sustain period Sk₂ᵢ may be applied to the subgroup G₂ᵢ after the address period EAk₂ᵢ is applied. Subsequently, the address period EAk₂₍ᵢ₊₁₎ and the sustain period Sk₂₍ᵢ₊₁₎ may be applied to the subgroup G₂₍ᵢ₊₁₎. In this case, the address period EAk₂ᵢ may be applied to the subgroup G₂ᵢ while the sustain period Sk₁ᵢ is applied to the subgroup G₁ᵢ of the first row group G₁in the subfield SFk. In addition, the address period EAk₁₍ᵢ₊₁₎ may be applied to the subgroup G₁₍ᵢ₊₁₎ of the first row group G₁while the sustain period Sk₂ᵢ is applied to the subgroup G₂ᵢ of the second row group G₂ in the subfield SFk.

As shown in FIG. 3, the address periods EAk₂₁ to EAk₂₈ and the sustain periods Sk₂₁ to Sk₂₂ may be sequentially applied to the subgroup G₂₁ to the subgroup G₂₈ of the second row group G₂. In an implementation (not shown), the address periods EAk₂₈ to EAk₂₁ and the sustain periods Sk₂₈ to Sk₂₁ may instead be sequentially applied to the subgroup G₂₈ to the subgroup G₂₁. In addition, the address periods and the sustain periods may be applied according to a different order in the first and second row groups G₁and G₂.

The respective subfields SF2 to SFL of the first row group G₁will now be described in further detail. Wall charges may be erased by erase-discharging discharge cells that are selected to be non-light emitting cells from among light emitting cells of the first subgroup G₁₁ during the address period EAk₁₁ of the subfield SFk of the first row group G₁. Light emitting cells of the first subgroup G₁₁ may be sustain-discharged during the sustain period Sk₁₁. Subsequently, wall charges may be erased by erase-discharging discharge cells that are selected to be non-light emitting cells from among light emitting cells of the second subgroup G₁₂ during the address period EAk₁₂, and light emitting cells of the second subgroup G₁₂ may be sustain-discharged during the sustain period Sk₁₂. At this time, the light emitting cells of the first subgroup G₁₁ may be sustain-discharged. The address periods EAk₁₃ to EAk₁₈ and the sustain periods Sk₁₃ to Sk₁₈ may be applied to the subgroups G₁₃ to G₁₈ in the same manner as described above. The light emitting cells of the subgroup G₁ᵢ, the subgroups G₁₁ to G₁₍ᵢ₋₁₎, and the subgroups G₁₍ᵢ₊₁₎ to G₁₈ may be sustain-discharged. The light emitting cells of the subgroups G₁₁ to G₁₍ᵢ₋₁₎ may correspond to the light emitting cells that have not experienced an erase discharge during the respective address periods EAk₁₁ to EAk₁₍ᵢ₋₁₎. The light emitting cells of the subgroups G₁₍ᵢ₊₁₎ to G₁₈ may correspond to the light emitting cells that have not experienced the erase discharge during the respective address periods EA(k−1)₁₍ᵢ₊₁₎ to EA(k−1)₁₈.

In addition, the light emitting cells of the subgroup G₁ᵢ may be sustain-discharged until the sustain period SK₁₍ᵢ₋₁₎ before a subsequent address period EA(k+1)₁ᵢ of the subgroup G₁ᵢ of the first subgroup of the subfield SF(k+1). Thus, the light emitting cells of the subgroup G₁ᵢ may be sustain-discharged during eight sustain periods.

The address periods EA2₁₁ to EA2₁₈ and EAL₁₁ to EAL₁₈, and the sustain periods S2₁₁ to S2₁₈ and SL₁₁ to SL₁₈, may be applied to each of the subgroups G₁₁ to G₁₈ of the respective subfields SF2 to SFL. In this way, the discharge cells that are set to the light emitting state during the sustain periods S1₁ and S1₂ may be sustain-discharged until the discharge cells are erase-discharged in the respective subfields SF2 to SFL, whereby they may be switched to the non-light emitting state. After the discharge cells in the light emitting state are switched to the non-light emitting state due to the erase-discharge, no sustain discharge may be generated in the corresponding subfield. A weight value of each of the subfields SF2 to SFL may correspond to a sum of the lengths of eight sustain periods of the respective subfields.

When the sustain period SL₁₈ is applied to the subfield SFL, the sustain discharge may be performed eight times in the subgroup G₁₁, seven times in the subgroup G₁₂, six times in the subgroup G₁₃, five times in the subgroup G₁₄, four times in the subgroup G₁₅, three times in the subgroup G₁₆, twice in the subgroup G₁₇ and once in the subgroup G₁₈. However, it may be desirable for the subgroups G₁₁ to G₁₈ to have the same number of sustain discharges. For this purpose, the last subfield SFL of the first row group G₁ may include erase periods ER₁₁ to ER₁₇ and additional sustain periods SA₁₂ to SA₁₈.

In further detail, the subgroup G₁₁, where the sustain discharge is performed eight times immediately before subsequent erase periods, may not need an additional sustain period. Therefore, wall charges formed in the light emitting cells of the subgroup G₁₁ may be erased during the erase period ER₁₁. Then, the light emitting cells of the subgroups G₁₁ to G₁₈ may emit light during the additional sustain period SA₁₂. In this case, since the wall charges formed in the light emitting cells of the subgroup G₁₁ were erased during the erase period ER₁₁, the additional sustain discharge is performed once in the light emitting cells of the subgroups G₁₂ to G₁₈ during the additional sustain period SA₁₂.

In addition, since the subgroup G₁₂, where the sustain discharge is performed eight times due to the additional sustain period SA₁₂, may not need an additional sustain discharge, and wall charges formed in the light emitting cells of the subgroup G₁₂ may be erased during the erase period ER₁₂. Then, the light emitting cells of the subgroups G₁₁to G₁₈ may emit light during the additional sustain period SA₁₃. In this case, the wall charges formed in the light emitting cells of the subgroups G₁₁ and G₁₂ were erased during the respective erase periods ER₁₁ and ER₁₂, and therefore the additional sustain discharge may be performed once in the light emitting cells of the subgroups G₁₃ to G₁₈ during the additional sustain period SA₁₃.

Subsequently, wall charges formed in the light emitting cells of the subgroup G₁₃ may be erased during the erase period ER₁₃, since the subgroup G₁₃, where the sustain discharge is performed eight times due to the additional sustain period A₁₃, may not need to experience an additional sustain discharge. Then, the light emitting cells of the subgroups G₁₁ to G₁₈ may emit light during the additional sustain period SA₁₄. In this case, since the wall charges formed in the subgroups G₁₁to G₁₃ were erased during the respective erase periods ER₁₁ to ER₁₃, the additional sustain discharge may be performed once in the light emitting cells of the subgroups G₁₄ to G₁₈ respectively during the additional sustain period SA₁₄. Similarly, the same number of sustain discharges may be generated in the first to eighth subfields SF1 to SFL and may be set to correspond to each other by performing erase periods ER₁₄ to ER₁₇ and additional sustain periods SA₁₅ to SA₁₈.

An erase period ER₁₈ may be additionally performed so as to erase wall charges of the subgroup G₁₈ after the additional sustain period of the subgroup G₁₈. However, the erase period ER₁₈ may be omitted, since a reset period R may be applied to a subfield SF1 of the next consecutive field. The erase operation of the respective erase periods ER₁₁ to ER₁₈ may be sequentially performed for each row electrode of the respective subgroups, or may be simultaneously performed for all row electrodes of the respective row groups.

Referring again to FIG. 3, respective subfields SF2 to SFL of the second row group G₂ may be the same as those of the first row group G₁.

Referring to FIGS. 3 and 4, one field may be divided into 16 subfields SF1 to SF16. Each of the subgroups G₁₁to G₁₈ and G₂₁ to G₂₈ may have a plurality of subfields SF2 to SF16 shifted by a predetermined period from each other, as shown in FIG. 4. For example, the subfield SF2 for the subgroup G₁₂ may be shifted with respect to the subfield SF2 for the subgroup G₁₁ by the predetermined period. The predetermined period may correspond to a sum of an address period EAk₁ᵢ (or EAk₂ᵢ, for the corresponding subgroup in the row group G₂) of the subgroup G₁ᵢ (G₂ᵢ) and a sustain period Sk₁ᵢ (Sk₂ᵢ) of the subgroup G₁ᵢ (G₂ᵢ).

In addition, the subfields of the second row group G₂ may be shifted with respect to those of the first row group G₁. In detail, assuming that the length of the address period EAk₁ᵢ (EAk₂ᵢ) of one of the subgroups G₁ᵢ (G₂ᵢ) corresponds to the length of the sustain period Sk₁ᵢ (Sk₂ᵢ) of one of the subgroups G₁ᵢ (G₂ᵢ), a starting point of the respective subfields SF2 to SF16 of the second row group G₂ may be shifted by a period between a starting point of the respective subfields SF2 to SF 16 of the first row group G₁and the address period EAk₁ᵢ (EAk₂ᵢ). For example, referring to FIG. 3, the starting point of the subfield SF2 of the second row group G₂ may be shifted, with respect to the starting point of the subfield SF2 of the first row group G₁, by a period equal to the address period EA2₁₁ of the subgroup G₁₁ of the first row group G₁.

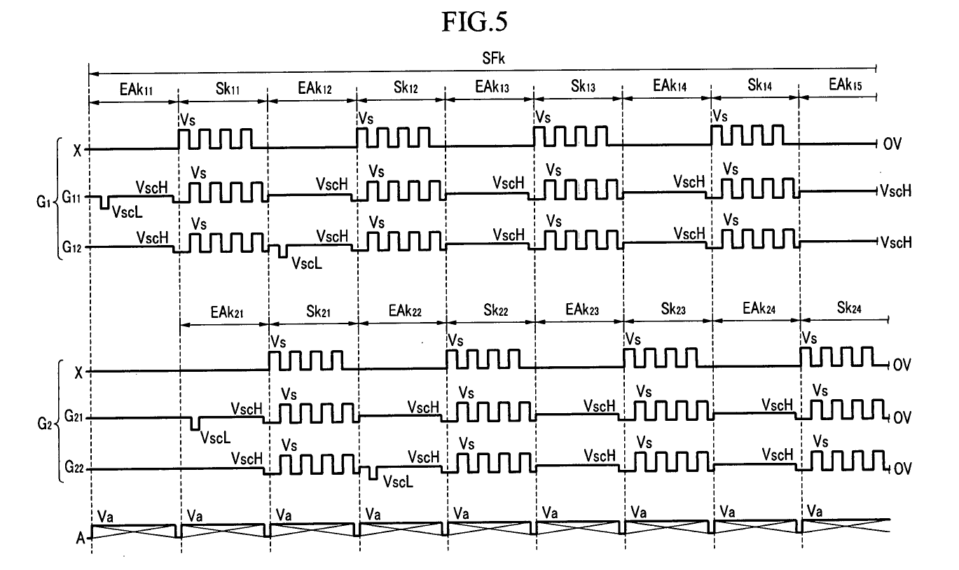

FIG. 5 illustrates a driving waveform of a plasma display device in the driving method of FIG. 2. Referring to FIG. 5, during the address period EAk₁₁ of the subgroup G₁₁ of the subfield SFk, a scan pulse having a VscL voltage may be applied to a Y electrode of the subgroup G₁₁, while a reference voltage, e.g., 0V, may be applied to the X electrodes of the first row group G₁. An address pulse, e.g., a positive voltage pulse, may be applied to an A electrode of a light emitting cell that is selected to be a non-light emitting cell from among light emitting cells corresponding to the Y electrode to which the scan pulse is applied. An erase discharge may be generated in the light emitting cell to which the scan pulse having the VscL voltage and the address pulse having the positive voltage are applied, so that wall charges formed on the X and Y electrodes may be erased and the selected light emitting cell may be switched to the non-light emitting state.

In addition, a VscH voltage, which may be greater than the VscL voltage, may be applied to a Y electrode where the scan pulse is not applied among the plurality of Y electrodes of the first row group G₁, and the reference voltage may be applied to an A electrode where the address pulse is not applied.

Although FIG. 5 shows that the scan pulse is applied to one Y electrode of the address period EAk₁₁, the scan electrode driver 400 may sequentially select a Y electrode to which the scan pulse is applied from among the plurality of Y electrodes of the first subgroup G₁₁ during the address period EAk₁₁. For example, vertically arranged Y electrodes may be sequentially selected in a single driving algorithm. When one of the Y electrodes is selected, the address electrode driver 300 may select discharge cells to be turned on from among discharge cells corresponding to the selected Y electrode. That is, the address electrode driver 300 may select a discharge cell to which an address pulse having the Va voltage is applied from among the A electrodes A1 to Am.

During the sustain period Sk₁₁ of the subgroup G₁₁, a sustain discharge pulse, which may have a high level voltage (Vs voltage in FIG. 5) alternating with a low level voltage (0V in FIG. 5), may be applied to a plurality of X electrodes and a plurality of Y electrodes of the first row group G₁so as to sustain-discharge the light emitting cells of the subgroup G₁₁. The sustain discharge pulse applied to the X electrodes may have a reverse phase of the sustain discharge pulse applied to the Y electrodes. That is, when the Vs voltage is applied to the X electrodes, 0V may be applied to the Y electrodes, and when the Vs voltage is applied to the Y electrodes, 0V may be applied to the X electrodes. In this case, discharge cells that have not experienced an erase discharge during the address period EAk₁₁ from among discharge cells in the light emitting state in the previous subfield SF(k−1) may be switched to the light emitting state and experience a sustain discharge.

The address period EAk₂₁ of the subgroup G₂₁ of the second row group G₂ may be applied during the sustain period Sk₁₁ of the subgroup G₁₁ of the first row group G₁. In the address period EAk₂₁, the scan pulse having the VscL voltage may be applied to a plurality of Y electrodes of the subgroup G₂₁ while the reference voltage is applied to an X electrode of the second row group G2, and an address pulse having a positive pulse may be applied to an A electrode of a discharge cell to be turned off that is selected from among light emitting cells corresponding to the Y electrode where the scan pulse is applied. The light emitting cell supplied with the scan pulse having the VscL voltage and the address pulse having the positive voltage may experience an erase discharge, so that wall charges formed on the X and Y electrodes may be erased and the light emitting cell may be switched to the non-light emitting state.

A Y electrode to which the scan pulse is not applied, from among the plurality of Y electrodes of the second row-group G2, may be supplied with the VscH voltage, and an A electrode to which the address pulse is not applied may be supplied with the reference voltage.

Subsequently, the sustain period Sk₂₁of the subgroup G₂₁ of the second row group G₂ may be performed. During the sustain period Sk₂₁, a sustain discharge pulse may be applied to the plurality of X electrodes of the second row group G2 and the plurality of Y electrodes of the second row group G2, and thus a sustain discharge may be generated in the corresponding light emitting cells. The sustain discharge pulse applied to the X electrodes may have an opposite phase to that of the sustain discharge pulse applied to the Y electrodes.

The address period EAk₁₂ of the subgroup G₁₂ of the first row group G₁may be performed while the sustain period Sk₂₁ is performed. The address period EAk₁₂ may be substantially the same as the address period EAk₁₁. Further, the address periods EAk₁₃ to EAk₁₈ of the subgroups G₁₃ to G₁₈ of the first row group G₁may be performed as described above, the sustain period Sk₁₂ to Sk₁₈ of the subgroups G₁₂ to G₁₈ of the first row group G₁may be performed as described above, the address periods EAk₂₂ to EAk₂₈ of the subgroups G22 to G28 of the second row group G₂ may be performed as described above, and the sustain periods Sk₂₂ to Sk₂₈ of the subgroups G₂₂ to G₂₈ of the second row group G₂ may be performed as described above.

As described above, the sustain period Sk₂₍ᵢ₋₁₎ may be applied to row electrodes of the second row group G₂ during the address period EAk₁ᵢ of each of the row electrodes of the first row G₁, and the sustain period Sk₁ᵢ may be applied to row electrodes of the first row group G₁during the address period EAk₂ᵢ of each of the row electrodes of the second row group G₂. That is, the address period EAk₁ᵢ or EAk₂ᵢ may overlap, i.e., may be performed during the sustain period Sk₂₍ᵢ₋₁₎ or Sk₁ᵢ, respectively, rather than separating the address period EAk₁ᵢ or EAk₂ᵢ and the sustain period Sk₂₍ᵢ₋₁₎ or Sk₁ᵢ. Therefore, the length of one subfield may be reduced.

In addition, priming particles formed during the sustain periods Sk₁₁ to Sk₁₈ and Sk₂₁to Sk₂₈ may be efficiently used during the address period EAk₁₂ to EAk₁₇ and EAk₂₂ to EAk₂₈, since the address periods EAk₁₂ to EAk₁₇ and EAk₂₂ to EAk₂₈ may be provided between sustain periods Sk₁₁ to Sk₁₈ and Sk₂₁to Sk₂₈ of each of the subgroups G₁₁to G₁₈ and G₂₁ to G₂₈. Thus, a scan pulse width may be reduced, which may enable a high speed scan. In addition, the contrast ratio may be increased by preventing a strong discharge from being generated during the reset period.

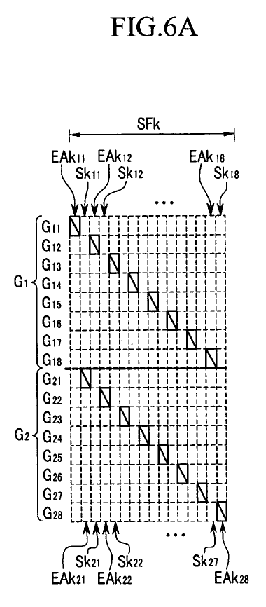

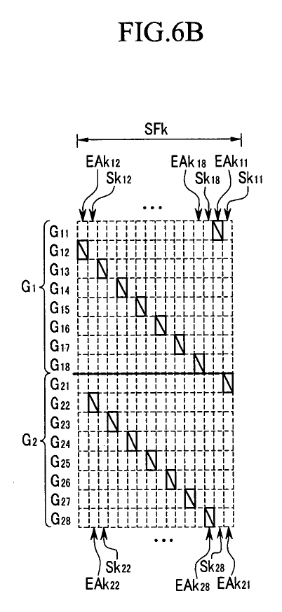

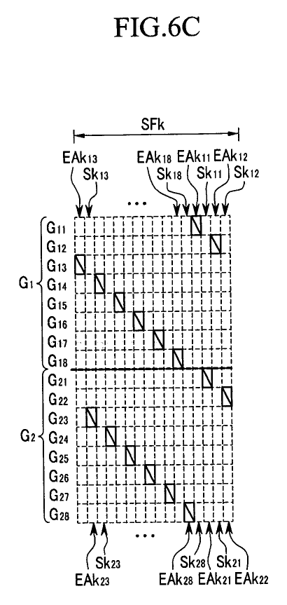

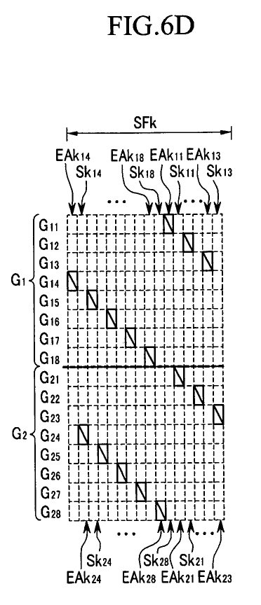

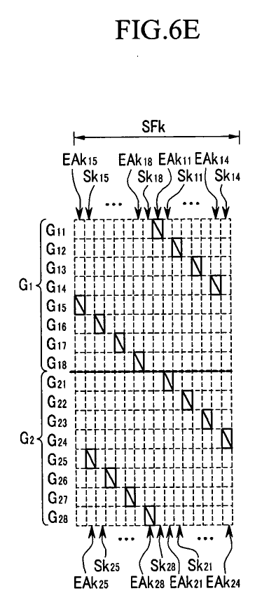

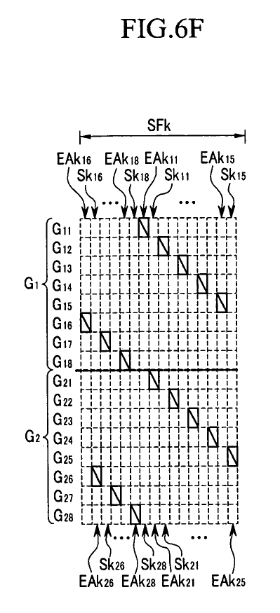

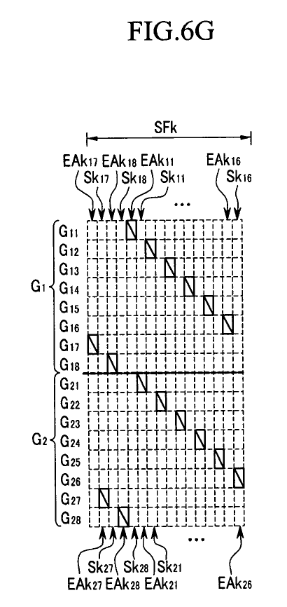

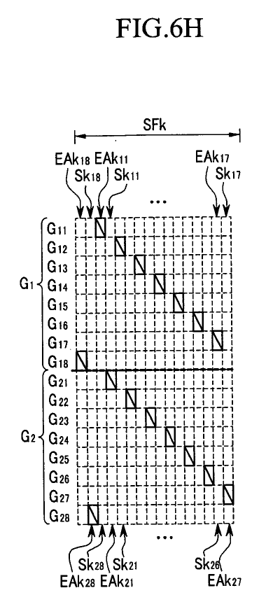

The operations described above may result in a sustain discharge being generated in a subgroup where an address period is performed earlier than other subgroups, even though the number of sustain discharge pulses between each of the subgroups may be the same. Accordingly, a luminance difference may be generated between the respective subgroups. Such a luminance difference may be reduced using a driving method that will now be described in connection with FIGS. 6A to 6H.

FIGS. 6A to 6H illustrate, respectively, an order of address periods of subgroups in first to eighth fields in the driving method of FIG. 2. FIGS. 6A to 6H generally illustrate a k-th subfield SFk from among the plurality of subfields SF2 to SF16, i.e., 2≦k≦L. L may be equal to 16.

Referring to FIGS. 6A to 6H, the order of address periods EAk₁₁ to EAk₁₈ and EAk₂₁ to EAk₂₈ of respective subgroups G₁₁ to G₁₈ and G₂₁ to G₂₈ for subfields SF2 to SF16 may be changed for each field. The controller 200 may control the order.

In detail, in the first field, as shown in FIG. 6A, address periods EAk₁₁, EAk₂₁, EAk₁₂, EAk₂₂, EAk₁₃, EAk₂₃, EAk₁₄, EAk₂₄, EAk₁₅, EAk₂₅, EAk₁₆, EAk₂₆, EAk₁₇, EAk₂₇, EAk₁₈, and EAk₂₈ may applied for an addressing operation to be performed for the respective subgroups G₁₁ and G₂₁, the subgroups G₁₂ and G₂₂, the subgroups G₁₃ and G₂₃, . . . , and the subgroups G₁₈ and G₂₈ in the subfield SFk.

In the second field, as shown in FIG. 6B, the address periods EAk₁₂, EAk₂₂, EAk₁₃, EAk₂₃, EAk₁₄, EAk₂₄, EAk₁₅, EAk₂₅, EAk₁₆, EAk₂₆, EAk₁₇, EAk₂₇, EAk₁₈, EAk₂₈, EAk₁₁, and EAk₂₁ may be applied for the addressing operation to be performed for the respective subgroups G₁₂ and G₂₂, the subgroups G₁₃ and G₂₃, . . . , the subgroups G₁₈ and G₂₈, and the subgroups G₁₁ and G₂₁ in the subfield SFk.

In the third field, as shown in FIG. 6C, the address periods EAk₁₃, EAk₂₃, EAk₁₄, EAk₂₄, . . . , EAk₁₈, EAk₂₈, EAk₁₁, EAk₂₁, EAk₁₂, and EAk₂₂ may be applied for the addressing operation to be performed for the respective subgroups G₁₃ and G₂₃, the subgroups G₁₄ and G₂₄, . . . , the subgroups G₁₈ and G₂₈, the subgroups G₁₁and G₂₁, and the subgroups G₂₁ and G₂₂ in the subfield SFk

In the fourth field, as shown in FIG. 6D, the address periods EAk₁₄, EAk₂₄, EAk₁₅, EAk₂₅, . . . , EAk₁₈, EAk₂₈, EAk₁₁, EAk₂₁, EAk₁₂, EAk₂₂, EAk₁₃, and EAk₂₃ may be applied for the addressing operation to be performed for the respective subgroups G₁₄ and G₂₄, the subgroups G₁₅ and G₂₅, . . . , the subgroups G₁₈ and G₂₈, the subgroups G₁₁ and G₂₁, the subgroups G₁₂ and G₂₂, and the subgroups G₁₃ and G₂₃ in the subfield SFk.

In the fifth field, as shown in FIG. 6E, the address periods EAk₁₅, EAk₂₅, EAk₁₆, EAk₂₆, . . . , EAk₁₈, EAk₂₈, EAk₁₁, EAk₂₁, . . . , EAk₁₄, and EAk₂₄ may be applied for the addressing operations to be performed for the respective subgroups G₁₅ and G₂₅, the subgroups G₁₆ and G₂₆, . . . , the subgroups G₁₈ and G₂₈, the subgroups G₁₁and G₂₁, the subgroups G₁₂ and G₂₂, . . . , and the subgroups G₁₄ and G₂₄ in the subfield SFk.

In the sixth field, as shown in FIG. 6F, the address periods EAk₁₆, EAk₂₆, EAk₁₈, EAk₂₈, EAk₁₁, EAk₂₁, EAk₁₂, EAk₂₂, . . . , EAk₁₅, and EAk₂₅ may be applied for the addressing operation to be performed for the respective subgroups G₁₆ and G₂₆, . . . , the subgroups G₁₈ and G₂₈, the subgroups G₁₁ and G₂₁, the subgroups G₁₂ and G₂₂, . . . , and the subgroups G₁₅ and G₂₅ in the subfield SFk.

In the seventh field, as shown in FIG. 6G, the address periods EAk₁₇, EAk₂₇, EAk₁₈, EAk₂₈, EAk₁₁, EAk₂₁, EAk₁₂, EAk₂₂, . . . , EAk₁₆, and EAk₂₆ may be applied for the addressing operation to be performed for the respective subgroups G₁₇ and G₂₆, the subgroups G₁₈ and G₂₈, the subgroups G₁₁and G₂₁, the subgroups G₁₂ and G₁₂, . . . , and the subgroups G₁₆ and G₂₆ in the subfield SFk.

In the eighth field, as shown in FIG. 6H, the address periods EAk₁₈, EAk₂₈, EAk₁₁, EAk₂₁, EAk₁₂, EAk₂₂, . . . , EAk₁₇, and EAk₂₇ may be applied for the addressing operation to be performed for the respective subgroups G₁₈ and G₂₈, the subgroups G₁₁and G₁₁, the subgroups G₁₂ and G₂₂, . . . , and the subgroups G₁₇ and G₂₇ in the subfield SFk.

In a ninth field consecutive to the eighth field, the order may return to the order of the first field, i.e., the orders of the first and ninth fields may be the same.

As described above, a luminance difference occurring between each subgroup may be reduced by driving the row electrodes over eight fields wherein an address period of each subgroup is changed through the eight fields.

Each field of the eight fields may be driven in correspondence with the addressing operation order as shown in FIG. 6A to FIG. 6H, although the method is not restricted thereto. For example, the subgroups may be shifted by more than one subgroup, the order may be varied, the starting subgroup may be varied, etc. Further, the order in one row group may be different from the order in another row group within a given field.

As described above, a plurality of row electrodes may be divided into first and second row groups, and row electrodes of the first and second row electrodes may be divided into respective pluralities of subgroups. An address period for each of the subgroups of the first and second row groups may be performed in each subfield of one field, and a sustain period may be performed between the respective address periods of the respective subgroups. In addition, the address period may be applied to each subgroup of the second row group while the sustain period is applied to each subgroup of the first row group. Similarly, the sustain period may be applied to each subgroup of the first row group while the address period is applied to each subgroup of the second row group.

An address period may be performed between sustain periods of the respective row groups, and therefore priming particles formed during the sustain period may be sufficiently utilized during the address period, which may enable high speed scanning by reducing the width of a scan pulse. Grayscale may be represented by subfields consecutively turned on from the first subfield, and therefore a false contour may be prevented from being generated. In addition, a luminance difference occurring between subgroups may be reduced by changing an addressing operation order between subgroups for each field.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method for driving a plasma display device having a plurality of row electrodes and a plurality of discharge cells corresponding to the row electrodes, in which a field is divided into a plurality of subfields, the method comprising:
dividing the plurality of row electrodes into at least a first row group and a second row group;
dividing the first row group into a plurality of first subgroups;
dividing the second row group into a plurality of second subgroups;
address-discharging one of the first subgroups while sustain-discharging a corresponding one of the second subgroups during a predetermined subfield of a first field;
address-discharging the first subgroups in a first order during the predetermined subfield of the first field; and
address-discharging the first subgroups in a second order during a corresponding subfield of a second field, wherein the second field is consecutive to the first field.

2. The method as claimed in claim 1, further comprising:
address-discharging the second subgroups in the first order during the predetermined subfield of the first field; and
address-discharging the second subgroups in the second order during the corresponding subfield of the second field.

3. The method as claimed in claim 2, wherein a number n of each of the first and second subgroups is greater than 2, n being an integer, the method further comprising:
address-discharging each of the first and second subgroups in an n^{th} order during a corresponding subfield of a nth field; and
address-discharging each of the first and second subgroups in the first order during a corresponding subfield of an n+1^{th} field,
wherein the first through ninth fields are consecutive.

4. The method as claimed in claim 3, wherein a subgroup that is address-discharged last during the first field is address-discharged first during the nt field.

5. The method as claimed in claim 1, further comprising:
address-discharging the second subgroups in a third order during the predetermined subfield of the first field; and
address-discharging the second subgroups in a fourth order during the corresponding subfield of the second field.

6. The method as claimed in claim 1, further comprising:
sustain-discharging each of the first and second subgroups in the first order during the first field; and
sustain-discharging each of the first and second groups in the second order during the second field.

7. The method as claimed in claim 1, wherein:
the one of the first subgroups is address-discharged during a last portion of the predetermined subfield in the first field, and
the one of the first subgroups is address-discharged during a first portion of the predetermined subfield in the second field.

8. The method as claimed in claim 1, wherein:
address-discharging each of the first and second subgroups is done in a repeating cycle having a predetermined number of orders, such that the cycle repeats after a number of fields that is one greater than the number of orders, and
a subgroup that is address-discharged last during an initial field of the cycle is address-discharged first during a last field of the cycle.

9. The method as claimed in claim 1, wherein:
the row electrodes include sustain electrodes and scan electrodes,
each of the first subgroups is driven with a same sustain electrode signal, and
each of the first subgroups is driven with a different scan electrode signal, the different scan electrode signals being determined in accordance with the first order.

10. The method as claimed in claim 1, wherein:
a first subgroup of the plurality of first subgroups is address-discharged during an initial portion of the first field, and a second subgroup of the plurality of first subgroups is address-discharged after the first subgroup during the first field, and
the second subgroup of the plurality of first subgroups is address-discharged during an initial portion of the second field.

11. The method as claimed in claim 1, wherein consecutive address-discharging operations alternate between the first and second row groups and increase sequentially within row groups in a repeating cycle.

12. The method as claimed in claim 11, wherein an initial address-discharging operation is performed on a first subgroup of the plurality of first subgroups, a first subsequent address-discharging operation is performed on a first subgroup of the plurality of second subgroups, and a second subsequent address-discharging operation is performed on a second subgroup of the plurality of first subgroups.

13. A plasma display device, comprising:
a plasma display panel having a plurality of row electrodes and a plurality of discharge cells corresponding to the row electrodes;
a controller configured to divide the plurality of row electrodes into at least a first row group and a second row group, to divide the first row group into a plurality of first subgroups, and to divide the second row group into a plurality of second subgroups; and
a driver configured to address-discharge one of the first subgroups while sustain-discharging a corresponding one of the second subgroups during a predetermined subfield of a first field, to address-discharge the first subgroups in a first order during the predetermined subfield of the first field, and to address-discharge the first subgroups in a second order during a corresponding subfield of a second field, wherein the second field is consecutive to the first field.

14. The plasma display device as claimed in claim 13, wherein a number n of each of the first and second subgroups is greater than 2, n being an integer, and the driver address-discharges each of the first and second subgroups in an n^{th} order during a corresponding subfield of a n^{th} field, and address-discharges each of the first and second subgroups in the first order during a corresponding subfield of an n+1^{th} field, the first through ninth fields being consecutive.

15. The plasma display device as claimed in claim 14, wherein a subgroup that is address-discharged last during the first field is address-discharged first during the n^{th} field.

16. The plasma display device as claimed in claim 13, wherein the driver address-discharges the second subgroups in a third order during the predetermined subfield of the first field, and address-discharges the second subgroups in a fourth order during the corresponding subfield of the second field.

17. The plasma display device as claimed in claim 13, wherein the driver sustain-discharges each of the first and second subgroups in the first order during the first field, and sustain-discharges each of the first and second groups in the second order during the second field.

18. The plasma display device as claimed in claim 13, wherein:
the driver address-discharges each of the first and second subgroups in a repeating cycle having a predetermined number of orders, such that the cycle repeats after a number of fields that is one greater than the number of orders, and
a subgroup that is address-discharged last during an initial field of the cycle is address-discharged first during a last field of the cycle.

19. The plasma display device as claimed in claim 13, wherein:
the driver address-discharges a first subgroup of the plurality of first subgroups during an initial portion of the first field, and address-discharges a second subgroup of the plurality of first subgroups after the first subgroup during the first field, and
the driver address-discharges the second subgroup of the plurality of first subgroups during an initial portion of the second field.

20. The plasma display device as claimed in claim 13, wherein consecutive address-discharging operations alternate between the first and second row groups and increase sequentially within row groups in a repeating cycle,
wherein the driver:
performs an initial address-discharging operation on a first subgroup of the plurality of first subgroups,
performs a first subsequent address-discharging operation on a first subgroup of the plurality of second subgroups, and
performs a second subsequent address-discharging operation on a second subgroup of the plurality of first subgroups.
